(19) United States
(12) Patent Application Publication
(10) Pub. No.: US 2014/0260011 A1
(43) Pub. Date: Sep. 18, 2014

(54) WINDOW SILL WITH RAINWATER CHANNEL DRAINAGE

(71) Applicant: George E. Pettibone, Des Moines, WA (US)

(72) Inventor: George E. Pettibone, Des Moines, WA (US)

(21) Appl. No.: 14/205,018

(22) Filed: Mar. 11, 2014

Related U.S. Application Data
(60) Provisional application No. 61/780,837, filed on Mar. 13, 2013.

(51) Int. Cl. E06B 7/14; E06B 7/26; E06B 1/70

(52) U.S. Cl. CPC E06B 7/14; E06B 1/702; E06B 7/26
USPC 52/209

(57) ABSTRACT

An improved window sill system has a bottom frame structure that is part of a sill frame unit. The bottom frame has a water trough or channel extending across its length at a front edge facing outwardly of a window in which the sill system is to be installed. The water trough or channel has a top plate provided with a plurality of weep holes for capturing rainwater dripping down the window into the water trough or channel. A base plate is provided with screw holes for mounting the bottom frame to a surrounding window frame. An inner deflection wall deflects water captured in the water trough or channel from the screw holes for mounting the bottom frame of the sill system to the window frame.

This U.S. patent application claims priority to U.S. Provisional Application Ser. No. 61/780,837 filed on Mar. 13, 2013, the contents of which are herein incorporated by reference in its entirety.

### BACKGROUND OF INVENTION

Window sill systems in current use have basic flaws, including but not limited to the following:

A. Sheet metal, plastic, rubber or synthetic membrane, stainless steel sheets, aluminum extrusions, must be fastened to the building by some mechanical form, such as screws or bolts, nails or all threaded rods.

B. Most of these fasteners end up in what is referred to as the “wet-zone” which where we expect to capture some amount of moisture/water and keep it from entering the building envelope. Holes are drilled in these conventional window sill flashings for these fasteners. Sealant is normally applied to the head of fasteners to try to keep surroundings standing water from seeping through the holes and into the building substrate. Expansion and contraction, heat and cold temperatures, building movement, building sway, water laying in the sill system for a prolonged time stressed and loads from the window system, wind loads called together to cause leakage of water into the building.

C. The fasteners, of thousands of different brands, types, sizes, materials, widths, of window doors, or other exterior materials to or through metal sill flashings has a long history of failure. This is because the concept has built in flaws in its concept.

D. End dams are now being used and considered normal for the last twenty years or so. They are commonly just a piece of metal, flat or 90 degree angle shape, installed with sealant and or screws. These are to keep water from leaking t through the rights and left ends of the sill flashing. Unfortunately many installers did not think they were needed and never installed them.

E. The normal sill cannot be used for fastening window down to achieve real anchorage. Fasteners must go through the window sill, and penetrate the sill flashing, then several inches into a concrete floor or wall for instance, to gain a real sound anchorage to the building structure.

F. Water is widely recognized as being able to find its way into a window system, by all window manufactures. Weep holes have been around for over 65 years. Condensation can find its way into almost any window system. Negative pressure can be another water problem.

G. Windows must accommodate a minimum of (14) major design problems:

Wind load, wind pressure on positive plane.

Negative wind loads

Bending of framing materials

Deflection of glazing materials

Earthquakes

Water infiltration

Wind leakage, noise

Dead loading

Corrosion, coastal conditions, dissimilar metals

Heat and ultra-violent degradation of paint finishes, plastic or PVC components or framing.

Expansion and contraction

Uplift in major storm or hurricane

Marketability

Combinations of all of the above and more.

It is therefore deemed desirable to provide an improved window sill that would perform on a very large number of buildings, structural material, designs, wall conditions, window types, window brands, depth of window frames, weight of windows, width and height of window, single hung, double hung, jalousies, fixed, sliding casement, hopper, awning, louvered windows and such. It should also accommodate a very large number of doors to meet all of the above criteria. Doors could be of the type that swing in, swing out, singles or pairs, bi-folding doors, sliding patio doors, other sliding doors, vertical roll up, or slide up doors. The improved unit should also accommodate many other exterior forms of curtain wall, fenestrations, spandrel panels, decorative panels, stone veneer, louvers, sky lights and screened enclosures.

### SUMMARY OF INVENTION

In accordance with the present invention, an improved window sill system, of the type having a sill frame unit with quadrangular frame parts forming a rectangular opening for a window therein, has a bottom frame comprising:

a water trough or channel formed extending across a length of the bottom frame of the sill system at a front edge facing outwardly of a window in which the sill system is to be installed,

a horizontally-extending top plate on a top side of an upper channel space opposite said water trough or channel provided with a plurality of weep holes across a horizontal length thereof for capturing rainwater or condensation moisture seeping down the window installed in the window sill frame into the water trough or channel for draining water captured therein,

a horizontally-extending base plate provided with screw holes communicating into a lower interior space for mounting the bottom frame of the sill system to a corresponding part of a surrounding window frame, and

an inner deflection wall provided between the upper channel space for capturing rain water in the water trough or channel and the lower interior space for mounting the base plate to the bottom portion of the window frame, thereby deflecting any water captured in the water trough or channel from the screw holes for mounting the bottom frame which might otherwise become rusted or deteriorated.

Other objects, features, and advantages of the present invention will be explained in the following detailed description of preferred embodiments of the invention having reference to the appended drawings.

### BRIEF DESCRIPTION OF DRAWINGS

FIG. 1 shows an isometric sectional view of a preferred embodiment (bottom frame) of an improved window sill system in accordance with the present invention.

FIG. 2 shows a side sectional view of the bottom frame of the improved window sill system.

FIG. 3A shows a top view and FIG. 3B shows an exterior elevation view of the bottom frame of the improved window sill system.

FIG. 4A shows a bottom view and FIG. 4B shows an interior elevation view of the bottom frame of the improved window sill system.

FIG. 5 shows an isometric view of the bottom frame with end caps attached.

FIG. 6 shows an isometric sectional view of a shallow version of the bottom frame of the improved window sill system.

FIG. 7 shows a side sectional view of the shallow version of the bottom frame.

FIG. 8 shows a side sectional view of another version of the bottom frame of the improved window sill system having an extended lower rain flashing.

### DETAILED DESCRIPTION OF PREFERRED EMBODIMENTS

In the following detailed description of the invention, certain preferred embodiments are illustrated providing certain specific details of their implementation. However, it will be recognized by one skilled in the art that many other variations and modifications may be made given the disclosed principles of the invention.

Referring to FIG. 1, an isometric sectional view of a preferred embodiment shows the unique structure of a bottom frame of an improved window sill system in accordance with the present invention. The bottom frame is part of a quadrangular sill frame unit having a top frame (not shown), bottom frame 10, and opposite lateral frames (not shown) forming a rectangular opening for a window therein. In the bottom frame 10 shown, a water trough or channel 11 is formed extending across a length of the bottom frame of the sill system at a front edge 12 facing outwardly of a window in which the sill system is to be installed. On a top side a channel space opposite the water trough or channel 11 is provided a horizontally-extending top plate 13 provided with a plurality of weep holes 13a across a horizontal length thereof for capturing any rainwater or condensation moisture seeping down the window installed in the window sill frame. The rainwater or moisture seeping into the weep holes 13a flows down and is captured in the water trough or channel 11 for draining water captured therein. A horizontally-extending base plate 14 is provided with screw holes 14a and interior space for mounting the bottom frame 10 of the sill system to a bottom portion of the window frame (not shown). Similarly, the top portion and lateral portions of the window frame are mounted to the top frame and lateral frames of the sill system respectively (not shown).

An inner deflection wall 15 is provided between the upper channel space for capturing rain water in the water trough or channel 11 and the lower interior space for mounting the base plate 14 to the bottom portion of the window frame, thereby deflecting any water captured in the water trough or channel 11 from the screw holes 14a for mounting the bottom frame which might otherwise become rusted or deteriorated. The top plate 13 is mounted by set screws 13b to a portion of the deflection wall on which the top plate is seated. A cover 16 is snap-fitted onto an inner edge 15a of the deflection wall 15 which is seated flush with an inner edge 14b of the base plate 14. A pair of end caps 18 (see FIG. 5, described below) is mounted on opposite lateral ends of the bottom frame 11 of the sill system for sealing off the framed spaces between the lateral ends. Weep holes 12a are provided in the front edge 12 that communicate into the water trough or channel 11 for draining any water captured therein. A lower flashing 17 extends downwardly and outwardly from a lower portion of the front edge 12 below the weep holes 12a to deflect any dripping water away from the window frame and sill structures.

FIG. 2 shows a side sectional view of the bottom frame of the improved window sill system. FIG. 3A shows a top view and FIG. 3B shows an exterior elevation view of the bottom frame of the improved window sill system. FIG. 4A shows a bottom view and FIG. 4B shows an interior elevation view of the bottom frame of the improved window sill system.

The window sill system is designed to accept a wide variety of storefronts, windows, curtain wall, jalousies, louvers, etc, with permanent screwed in end caps or plates. As shown in the isometric external view of FIG. 5, the end caps would generally be about 2″ taller than the sill system, and extend down near the bottom of the sill system. End caps are the full depth of the window sill inside to outside. Caulking is applied to the end caps after they have been screwed onto the main exposed extrusion shape, marked GP1005 on these drawings. The removable top plate or lid, at approximately 4″ wide, allows for installation and inspection of the sealant. This creates more quality control.

The installation of weep holes 12a in the front edge 12 of the main bottom frame box shape is enhanced by installing baffle sponges. These open cell synthetic sponges which could be sized properly to fit in the bottom corner, water trough area would normally be approximately two inches long and installed from above the cavity with ease. The weep holes are designed to be drilled out or punched out. These weep holes should be somewhat elongated to be noticeable out of round or a true slot approximately twice as wide as tall to relieve a condition known as “surface water tension”. Water in a sill system, with little or no wind pressure will resist or not flow out of an ⅛″ diameter round weep hole set, nor a 3/16″ or ¼″ diameter round hole set. By drilling two holes, side by side, from the exterior, then working the ¼″ drill bit to remove the small web between holes, it quickly becomes a horizontal slot, about 9/16″ wide×¼″ high. On a short window sill over 5 feet wide more weep holes would be needed, spaced approximately 24″ O.C. typical.

The sill system can be installed up to 24 feet long approximately, as this is the range of normal limits for extruding, anodizing, shipping, boxing etc, in the commercial window business and the suppliers. Internal splice sleeves can be added if a project required longer, continuous runs of this system. Expansion and contraction can be accommodated in properly positioned, spaced and installed splice joints.

The bottom frame of the sill system is designed for maximum benefits, starting with its heavy-wall shape and thickness. Main parts are usually a ¼″ thick to allow for large windows to dead load on top of it, large bottom surface for plastic shims as required by field conditions, the ability to be partly cantilevered on a narrow wall condition, maximum resistance to warping, bending or settling, or staggered placement or straight alignment of a series of fasteners to building structure. The use of bolts or all thread rod and epoxy, up to ⅝″ diameter with washers and nuts, allowing for maximum attachment strength. These various options in fastener type, size and design are no longer sitting in a puddle of water, adding many years to the expected life cycle of the window sill, compared to manufactured systems currently on the market. The ¼″ thick upturned leg offers maximum wind load resistance, both inward and outward, a positive alignment with the large external shaped box, called GP1 005 on these drawings, positive lock-in feature, as a series of #1 0 screws or ¼″×20 screws or size, is installed from inside the building envelope, approximately 24″ on center. The dead load weight of the windows should cause the window sill exterior box to rest permanently and correctly upon the sill base. The screw heads are hidden from view by a snap-on interior cover.

The main exterior frame structure is built very strong, to handle heavy windows and a hurricane. The main cavity is going downhill all the way to the weep holes, therefore all water will drain out in a very rapid time. No water should ever get into the lower area where the structure fasteners occur. The weep holes on this extrusion have an eyebrow and set-back feature to help keep rainwater from entering the weep holes to a large extent. This main exposed box is built to accept the flat top cover plate shown in the drawings.

The top plate in these drawings is slid into place, to lock onto the exterior part of the sill frame. Holes are drilled through the top plate, towards the rear area and screws are installed to lock down the back part of the plate. On some window conditions countersinking may be required. Drain holes approximately ⅜″ in diameter are drilled through this flat plate to ensure that it causes water to promptly flow down into the sloping cavity below. In effect it becomes a “sieve” to perform as noted above. Holes could be 6-8″ on center, and hidden by the window itself. The dual hooks hidden on the underside of this flat cover plate allows the user the option of sliding a piece of ¼″×1″ aluminum bar stock or some in stainless steel, several inches long for enhanced attachment of a window above. The installer could fasten machine bolts or screws to resist in-outward movement as well as downward and uplift. This could be the cleanest and strongest attachment, with no real concerns about water leakage. The installer would run a bead of caulking in the corner of the sill frame just below where the snap-on cover attaches near the top, which is very normal in the industry.

The range of complementary parts could be made to accommodate unusual conditions in various large buildings, and have all of these benefits. The flat plate is designed to leak; the rest of the system is designed to never leak. The recent adoption of “Hurricane Codes” in some states that did not previously have them require a window sill that should last 70-100 years, and multiple hurricane level storms, without failure. Superior positive drainage, thick walled extrusions, depth of system can be customized with some general arrangement of all design concepts. The sill system is designed to accommodate hundreds of different window frames or brands.

The 2-inch “water table” sill provides a unique structure. “Water table” is known in the window and door industry as the height of the inside leg of a frame compared to the exterior leg or part of the frame. Water will try to climb up and over the interior leg on any window system, if driven by the wind pressure and speed. There are multiple levels of performance, based certified water testing procedures. The heights of the inner leg on sills of commercial grade aluminum patio doors are greater than that of a less expensive residential patio door for instance. Caulking on the exterior is paramount to any window or fenestration product and installation. This custom sill design offers a very professional application of the caulking and backer rod. Backer rod is common name for open or closed cell sponge (in a round shape normally) to stop the caulking from moving laterally into a cavity, so that it may be tooled as is common to the window fenestration business. Two-sided adhesion and proper depth-height ratio is readily achieved on this system.

FIG. 6 shows an isometric sectional view and FIG. 7 shows a side sectional view of a shallower version of the bottom frame of the improved window sill system, with its parts being otherwise similar to those shown and described with respect to FIGS. 1-4. The shallow version has a shorter depth that may be used for a shallower window frame.

FIG. 8 shows a side sectional view of another version of the bottom frame of the improved window sill system having an extended lower rain flashing 27, but with its parts being otherwise similar to those shown and described with respect to FIGS. 1-4.

It is to be understood that many modifications and variations may be devised given the above description of the general principles of the invention. It is intended that all such modifications and variations be considered as within the spirit and scope of this invention, as defined in the following claims.

1. An improved window sill system, of the type having a sill frame unit with quadrangular frame parts forming a rectangular opening for a window therein, said sill system having a bottom frame comprising:
a water trough or channel formed extending across a length of the bottom frame of the sill system at a front edge facing outwardly of a window in which the sill system is to be installed,
a horizontally-extending top plate on a top side of an upper channel space opposite said water trough or channel provided with a plurality of weep holes across a horizontal length thereof for capturing rainwater or condensation moisture seeping down the window installed in the window sill frame into the water trough or channel for draining water captured therein,
a horizontally-extending base plate provided with screw holes communicating into a lower interior space for mounting the bottom frame of the sill system to a corresponding part of a surrounding window frame, and
an inner deflection wall provided between the upper channel space for capturing rain water in the water trough or channel and the lower interior space for mounting the base plate to the bottom portion of the window frame, thereby deflecting any water captured in the water trough or channel from the screw holes for mounting the bottom frame which might otherwise become rusted or deteriorated.

2. An improved window sill system according to claim 1, wherein the top plate is mounted by set screws to a portion of the deflection wall on which the top plate is seated.

3. An improved window sill system according to claim 1, wherein a cover is snap-fitted onto an inner edge of the deflection wall which is seated flush with an inner edge of the base plate.

4. An improved window sill system according to claim 1, wherein weep holes are provided in a front edge of the bottom frame that communicate into the water trough or channel for draining any water captured therein.

5. An improved window sill system according to claim 4, wherein a lower flashing extends downwardly and outwardly from a lower portion of the front edge below the weep holes to deflect any dripping water away from the window frame and sill structures.

6. An improved window sill system according to claim 1, wherein a pair of end caps is mounted on opposite lateral ends of the bottom frame of the sill system for sealing off said lateral ends.

7. An improved window sill system according to claim 1, wherein the bottom frame of the improved window sill system has a shallow depth dimensioned for use with a correspondingly shallow window frame.
